(19) United States
(12) Patent Application Publication
(10) Pub. No.: US 2011/0073593 A1
(43) Pub. Date: Mar. 31, 2011

(54) SEPARABLE RAISED PLATFORM FOR MICROWAVE HEATING OF A FOOD PRODUCT

(75) Inventors: Kathryn Hupfer, Chicago, IL (US); Giselle Monique Moses, Chicago, IL (US); Bunlim Ly, Chicago, IL (US); Kenneth Pokusa, Darien, IL (US); Christopher Dunkle, Buffalo Grove, IL (US); Neil E. Darin, Grayslake, IL (US)

(73) Assignee: KRAFT FOODS GLOBAL BRANDS LLC, Northfield, IL (US)

(21) Appl. No.: 12/570,680

(22) Filed: Sep. 30, 2009

(51) Int. Cl. H05B 6/80

(52) U.S. Cl. 219/730

(57) ABSTRACT

Raised platforms having microwave susceptors thereon are provided, where the platforms are separable into two or more different platform components for use in heating either a larger food product or separately heating smaller food products. When the platform is separated into platform components, support is provided adjacent the area of separation.

### FIELD

This disclosure relates to a platform for microwave heating of a food product, and in particular a raised platform for microwave heating of a food product.

### BACKGROUND

Various containers, sheets, and platforms have been used for microwave heating of food products. Susceptors may be disposed on at least part of these structures to at least partially absorb microwaves during microwave cooking to heat a food product disposed in close proximity to the susceptors, and in particular food products having dough-based components. U.S. Pat. No. 5,688,427 details some of the desirable properties of utilizing an elevated platform with a susceptor during microwave heating. For example, elevating the susceptor from the floor of a microwave creates an insulating air layer resulting in more heat to the food product. Also, if vents are provided in the elevated platform, moisture can vent below the platform reducing the potential for a soggy food product.

Susceptors are often configured for one-time usage. Accordingly, a susceptor used to heat part of a food product or less than all of multiple food products may not be able to be used a second time to heat the remaining food product. Further, known elevated cooking platforms cannot simply be divided into smaller elevated platforms and still produce a high quality microwave-heated or cooked food product with the elevated platform sections. Two problems that can occur upon division of known elevated platforms are that an edge of the platform sections would undesirably rest on the floor of the microwave or a free edge adjacent the area of division would be without a sufficient brace to support the food product. A platform with one elevated edge and one edge resting on the microwave floor may not be able to retain the food product on the susceptor surface during heating. Even if the food product remained on at least part of the susceptor, the benefits of utilizing an elevated tray are reduced. For example, if the food product is at different elevations from the floor of a microwave oven, then the heating may be uneven and result in an undesirable food product. If the platform has an unsupported free edge, the platform can bow under the weight of the food product, either letting the food product slide from the susceptor surface or heating without the full susceptor surface in contact with the food product resulting in uneven heating and an undesirable food product. Additionally, adding more material to known elevated cooking platforms to increase rigidity can disadvantageously increase packaging costs and make such platforms uneconomical.

### SUMMARY

A separable raised susceptor platform for microwave heating of a food product is disclosed. The platform can be separated into two or more components each having a susceptor surface. This can advantageously permit microwave heating of either part or all of a food product that may be provided with the platform. If a user would like to heat all of the food product provided with the platform, then the food product can be put on the platform and heated in a microwave oven. If a user would like to heat only some of the food product provided with the platform, then the platform can be separated, a portion of the food product provided therewith put on the separated component of the platform, and then heated in a microwave. The separated components of the platform are advantageously configured to sufficiently support the food product in an elevated position above the floor of a microwave oven, thereby promoting suitable heating of the food product during microwaving.

Further, the platform can provide a number of advantages. The platform can require less packaging than compared to two separately packaged platforms. The platform can lead to operational savings by facilitating packaging assembly of two or more at a time. Finally, the platform allows a user to choose the quantity of food items to be heated in the microwave, i.e., the user can use the full platform to heat all of the food products at once or separate the platform to heat the food items at separate times.

In one aspect, the separable raised platform includes a support with a susceptor disposed thereon for microwave heating of the food product. The separable raised platform also includes legs depending from the periphery of the support to elevate the support. The separable raised platform is divisible into first and second raised platform sections, which are joined by an area of weakness. Each of the first and second raised platform sections include a part of the support, the legs depending from the part of the support, and a support leg configured to support an edge portion of the part of the support adjacent the area of weakness.

In another aspect, a separable raised platform is convertible from a joined configuration to a separated configuration to permit microwave heating of separate food products at either the same time or different times. The separable raised platform includes an area of weakness joining first and second raised platform sections, where each of the first and second raised platform sections include a support with a susceptor disposed thereon to support and heat and/or cook a food product. The first and second raised platform sections also include legs that support edge portions adjacent sides of the support. The legs include support legs adjacent a side of the support adjacent to the support of the other of the first and second raised platform sections. The area of weakness further is divisible to separate the first and second raised platform sections and convert the separable raised platform from the joined configuration to the separated configuration.

In yet another aspect, a separable platform is convertible from a joined configuration to a separated configuration to permit microwave heating of separate food products at either the same time or different times. The separable platform includes first and second platform sections. Each platform section includes a support with a susceptor disposed thereon to support and heat and/or cook a food product. Each section also includes walls extending from the support, the walls having a top disposed thereon. The first and second platform sections are connected by an area of weakness divisible to separate the first and second platform sections and convert the separable platform from the joined configuration to the separated configuration.

### BRIEF DESCRIPTION OF THE DRAWINGS

FIG. 1 is a perspective view of a first embodiment of a separable raised platform for microwave heating of a food product;

FIG. 2 is a top plan view of the separable raised platform of FIG. 1;

FIG. 3 is a perspective view of the separable raised platform of FIG. 1 showing the raised platform supporting two food products;

FIG. 4 is a perspective view of the separable raised platform of FIG. 1 showing the raised platform partially within outer packaging and supporting two individually-wrapped food products;

FIG. 5 is a perspective view of a second embodiment of a separable raised platform for microwave heating of a food product;

FIG. 6 is a top plan view of the separable raised platform of FIG. 5 in a separated configuration;

FIG. 7 is a perspective view of the separable raised platform of FIG. 5 in a separated and erected configuration;

FIG. 8 is another perspective view of the separable raised platform of FIG. 5 in the separated and erected configuration;

FIG. 9 is a perspective view of a third embodiment of the separable raised platform for microwave heating of a food product;

FIG. 10 is a top plan view of the separable raised platform of FIG. 9 in a separated configuration;

FIG. 11 is a perspective view of the separable raised platform of FIG. 9 in a separated and erected configuration;

FIG. 12 is another perspective view of the separable raised platform of FIG. 9 in the separated and erected configuration;

FIG. 13 is a perspective view of a fourth embodiment of the separable raised platform for microwave heating of a food product;

FIG. 14 is a perspective view of the separable raised platform of FIG. 13 in a partially separated configuration;

FIG. 15 is a perspective view of the separable raised platform of FIG. 13 in a separated and erected configuration;

FIG. 16 is a perspective view of a fifth embodiment of the separable raised platform for microwave heating of a food product;

FIG. 17 is a perspective view of the separable raised platform of FIG. 16 in a separated and erected configuration;

FIG. 18 is a perspective view of a sixth embodiment of the separable platform for microwave heating of a food product;

FIG. 19 is a perspective view of the separable platform of FIG. 18 in a partially opened configuration;

FIG. 20 is a perspective view of the separable platform of FIG. 18 in an opened configuration; and

FIG. 21 is a perspective view of the separable platform of FIG. 18 in an opened and separated configuration.

### DETAILED DESCRIPTION

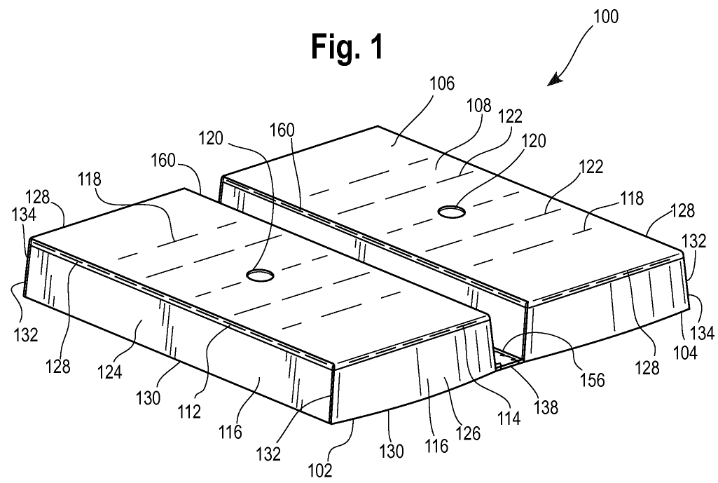

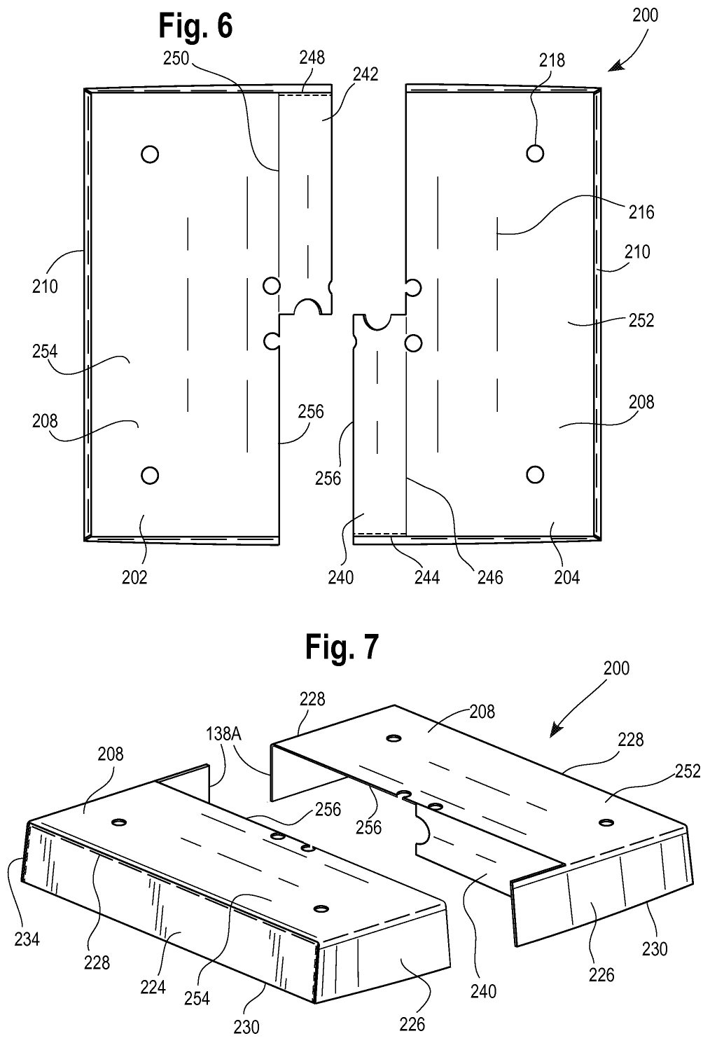

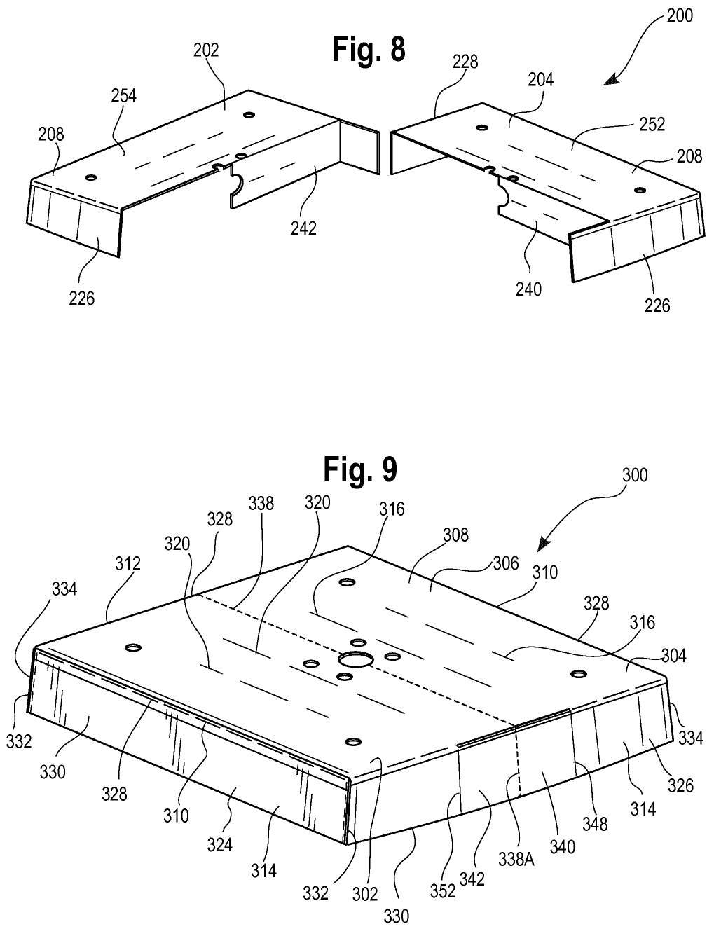

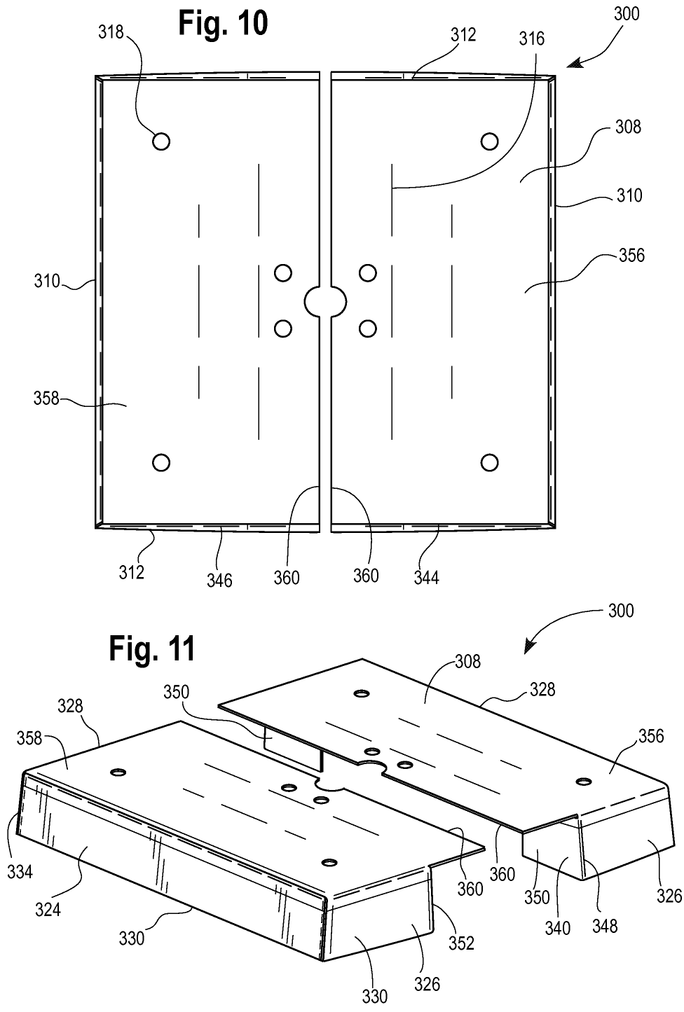

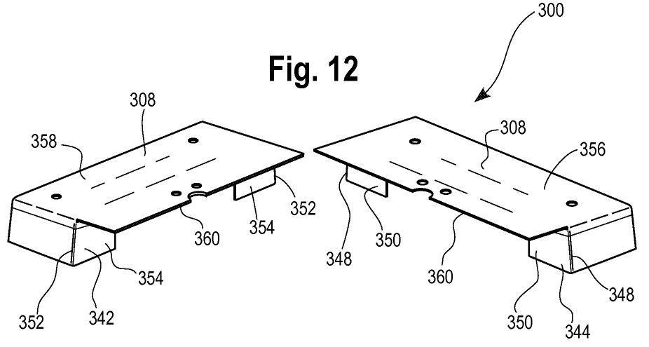

Exemplary embodiments of separable raised platforms for microwave heating in accordance with the above-discussed aspects are illustrated in FIGS. 1-12 and discussed herein. The separable raised platforms are separable from a joined configuration to a separated configuration. In the separated configuration, the separable raised platforms are separated via an area of weakness into first and second raised platform sections, and thus a food product or food products can be cooked at different times with one raised platform, while also elevating the food product above a floor or tray of the microwave during the cooking cycle to promote more even microwave heating. The first and second raised platform sections further include first and second support legs, respectively, to support an edge portion of the support adjacent the area of weakness.

More particularly, the separable raised platform includes a support for the food product during microwave heating thereof. In use, the support of the raised platform supports the food product at least partially on a susceptor at a position elevated above a bottom floor or tray of a microwave. The susceptor provides for conductive heating of portions of the food product in contact therewith. As discussed herein, a susceptor can include a shield material, a susceptor material, or a combination of both.

The separable raised platform further includes the area of weakness to facilitate converting the separable raised platform from the joined configuration to the separated configuration. The area of weakness spans the separable raised platform, so that when divided, the area of weakness generally bisects the separable raised platform into the first tray section and the second tray section. In order to support the weight of the food product after being separated and the support in the elevated position, the first tray section includes the first support leg and the second tray section includes the second support leg, both of which are positioned to elevate and support the edge portion of the first and section tray sections adjacent the area of weakness, respectively, after the separable raised platform is divided into the separated configuration.

Legs, for example, depending from a periphery of the support, elevate the support and the food product during microwave heating. In the illustrated generally rectangular supports, there is a leg depending from each of the four sides of the support. As noted below, however, the support may take any suitable closed general shape, and accordingly the number, shape, position and size of the legs may vary between support shapes. Additionally, the legs may take any suitable height, as long as the support and the food product supported thereon are sufficiently elevated above the floor or tray of the microwave to allow for proper microwave heating and venting.

In the first exemplary embodiment illustrated in FIGS. 1-4, the separable raised platform 100 is convertible from a joined configuration to a separated configuration having first and second raised platform sections 102, 104. The separable raised platform 100 could alternatively be composed of three or more raised platform sections. The separable raised platform 100 includes a support 106 for a food product 108 during microwave heating having a susceptor 110 thereon. The food product 108 can include one or more products, which may be separable. The susceptor 110 may be disposed across all or part of the support 106. The support 106 is generally rectangular having a pair of generally parallel side edges 112 and a pair of generally parallel end edges 114 to create the support periphery. Legs 116 depend from the support periphery to elevate the support 106 and the susceptor 110, and thus the food product 108, above the floor or tray of the microwave during microwave heating.

Turning now to more of the details of the legs 116, opposing side walls 124 depend from the pair of side edges 112 and opposing end walls 126 depend from the pair of end edges 114. Each of the side walls 124 and the end walls 126 is rectangular, having a top edge 128, an opposite bottom edge 130, and a pair of side edges 132. Specifically, the top edges 128 of the side walls 124 connect to the side edges 112 of the support 106 and the top edges 128 of the end walls 126 connect to the end edges 114 of the support 106. The end walls 126 join to the side walls 124 at four outside corners 134, where they are secured together to hold the separable raised platform 100 in an elevated position. The side walls 124 each have a pair of tabs 136 depending off of the pair of side edges 132. The tabs 136 are then adhered to the end walls 126, such as to an inside of the end walls 126 to preserve the aesthetics of the separable raised platform 100 and prevent the tabs 136 from becoming snared and separated from the end walls 126. In use, however, the side walls 124 could also secure to the end walls 126 by mechanical methods, such as a locking tab inserted into a slot or a tongue-and-groove mechanism. It will be understood that the end walls 126 could alternatively be secured to the side walls 124 by similar methods.

The end walls 126 are broken by the area of weakness 138 forming first end wall segments 140 of the first raised platform section 102 and second end wall segments 142 of the second raised platform section 104. The area of weakness 138 further divides the support 106 into a first part 144 of the first raised platform section 102 and a second part 146 of the second raised platform section 104. The first and second end wall segments 140, 142 connect to first and second support legs 148, 150 at four inside corners 152. The first and second support legs 148, 150 are rectangular, each having a top edge 154, an opposite bottom edge 156, and a pair of side edges 158. The top edges 154 of the first and second support legs 148, 150 connect to inner edges 160 of the first and second raised platform sections 102, 104.

So configured, the first and second raised platform sections 102, 104 provide support for and elevate the inner edges 160 and portions of the first and second parts 144, 146 of the support 106 proximate thereto during microwave heating. The first and second support legs 148, 150 connect to the first and second end wall segments 140, 142, respectively, by adhering tabs depending from the pair of side edges 158 to the inside of the first and second end wall segments 140, 142. As discussed above, however, the first and second support legs 148, 150 and the first and second end wall segments 140, 142 can be secured together by any suitable method.

In an alternative form, the first and second raised platform sections 102, 104 can be raised to different elevations. In this form, the first support leg 148 and the legs 116 of the first raised platform section 102 would have a substantially equal height. Similarly, the height of the second support leg 150 and the legs 116 of the second raised platform section 104 would be substantially equal and different from the first raised platform section 102.

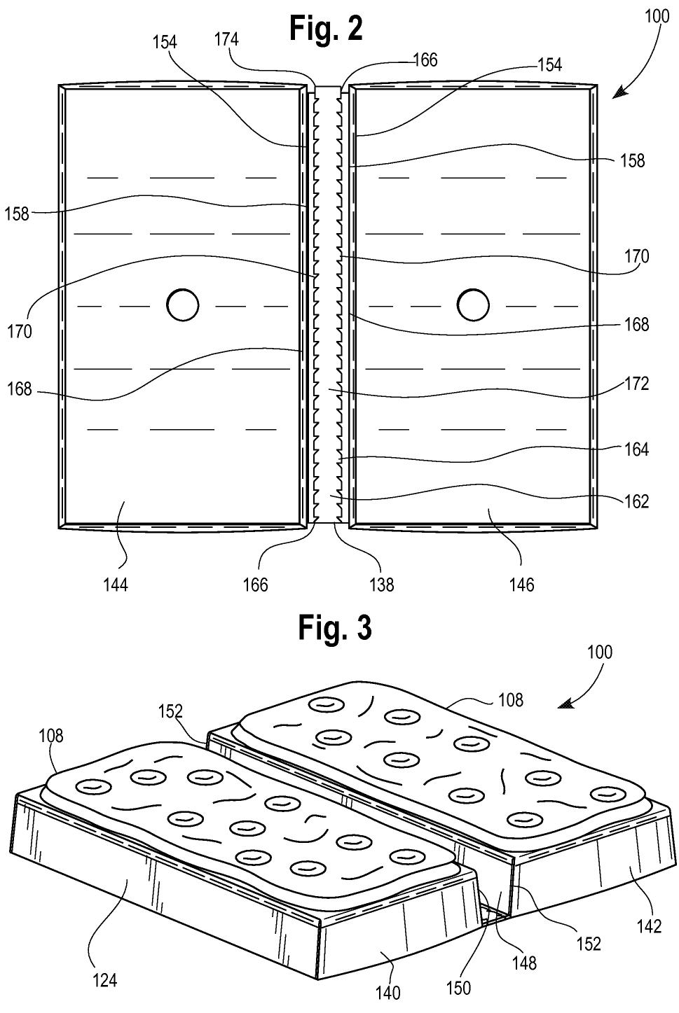

Turning now to the details of the area of weakness 138, as shown in FIG. 2. The area of weakness 138 generally bisects the separable raised platform 100 into the first raised platform section 102 and the second raised platform section 104. In the illustrated form, the area of weakness 138 includes a connecting panel 162 having a pattern of perforations 164. The connecting panel 162 is rectangular, having a pair of end walls 166 and a pair of side walls 168. As shown, the connecting panel 162 spans the gap between the first and second raised platform sections 102, 104, where the pair of side walls 168 connects to the bottom edges 156 of the first and second support legs 148, 150. Specifically, two generally parallel lines of perforations 170 extend the entire length between the end walls 166 of the connecting panel 162 to form a pull strip 172. The illustrated perforations 170 include a series of cuts with inwardly directed ends; however, other suitable perforation patterns can be utilized, such as straight lines, circular perforations, lines of unconnected angled lines, etc. A pull tab 174 protrudes beyond one of the end walls 166 of the connecting panel 162 to provide a gripping point for a user to pull on the pull strip 172, separating the two lines of perforations 170 and converting the separable raised platform 100 into its separated configuration of the first and second raised platform sections 102, 104. The area of weakness can also be a single or multiple perforations, scores, thinned die lines, offset partial cuts, or the like.

By one approach, the susceptor 110 does not extend over the area of weakness 138. In this approach, the susceptor 110 would extend to an area adjacent the area of weakness 138, such as spaced from the pattern of perforations 160. This configuration prevents edges or corners of metallic materials in the susceptor 110 from being exposed as a result of separating the area of weakness 138, also preventing the metallic edges or corners from arcing during microwave heating.

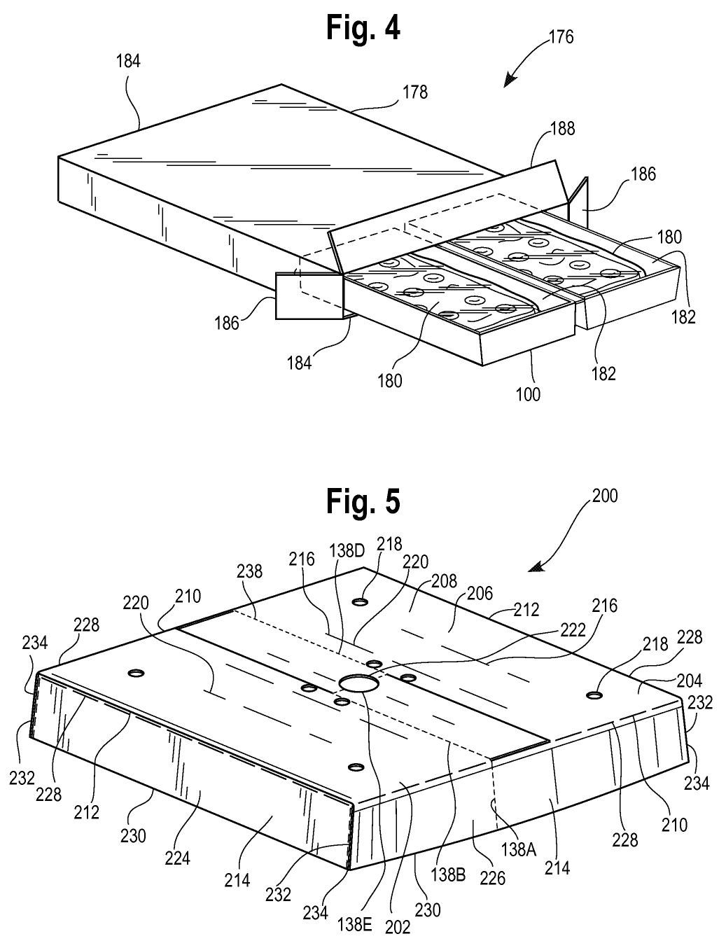

Referring now to FIG. 4, the separable raised platform 100 can be utilized as one part of a food product packaging 176. The food product packaging 176 includes an outer carton 178, the food product 108 or products sealed within inner film wrappers 180, and the separable raised platform 100. In the illustrated form, the first and second raised platform sections 102, 104 each form a cavity 182 defined by the side walls 124, the first and second support legs 148, 150, the first and second end wall segments 140, 142, and the support 106. By one approach, in order to minimize the packaging costs of the outer carton 178, the cavities 182 can be utilized to store the food product or products 108 during storage and transportation within the food product packaging 176. Preferably, the height of the end wall segments 140, 142, the first and second support legs 148, 150, and the side walls 124 of the separable raised platform 100 extend beyond the height of the food product 108 so that the food product 108 is confined within the limits of the cavity 182. This configuration provides additional protection for the food product 108 against damage caused during storage, transportation, and handling. The food product or products 108 are wrapped within the inner film wrapper 180 as is known for preservation and protection. The food products 108 are then placed within the cavities 182 of the separable raised platform 100 and then the separable raised platform 100 storing the food products 108 therein is inserted into the outer carton 178. In one form, the outer carton 178 is formed of a paperboard blank, having two ends 184 closed by folding over two pairs of opposing side flaps 186 and adhering two pairs of opposing end flaps 188. It will be understood, however, that the outer carton 178 can be composed of other suitable materials, such as, cardboard, plastic, or metal, and that the carton can be closed by other suitable methods, such as, hot sealing, cold sealing, or mechanically, by a locking tab or a tongue-and-groove.

So configured, the separable raised platform 100 is convertible from the joined configuration to the separated configuration. The joined configuration can be utilized to cook a large or multiple food products at a single time and the separated configuration can be utilized to cook a portion of the large food product or single food products at different times. The separable raised platform 100 further provides support legs 148, 150 to support the inner edge 160 of the first and second raised platform sections 102, 104 adjacent the area of weakness 138 and the first and second parts 144, 146 of the support 106 proximate thereto when in the separated configuration. Thus, in the separated configuration the platform sections 102 and 104 can support the food product or products in the elevated positions, including adjacent where the sections 102 and 104 were previously joined by the area of weakness 138.

To provide for the ventilation of the food product 108 during microwave heating, the support 106 and susceptor 110 have a plurality of vent slits 118 and holes 120 therethrough. The vent slits 118, as illustrated, are aligned in a series of five generally parallel rows 122, each row having a number of spaced slits 118. The holes 120 are provided in the center of the first and second raised platform sections 102, 104. Additional vent slits 118 are provided on the side edges 112 and the end edges 114 of the support 106. It will be understood, however, that other combinations, quantities, and patterns of the slits 118 and/or holes 120 can be utilized to optimize the ventilation of the specific food product 108 for which the separable raised platform 100 is manufactured.

In accordance with one example of the first embodiment of the separable raised platform 100, the support 106 may be about 7 inches long by about 8.75 inches wide, where the first and second parts 144, 146 of the support 106 are about 7 inches long by about 3.75 inches wide. The legs 116 and the first and second support legs 144, 146 may have a height of about 1 inch. The connecting panel 162 may be about 0.625 inches wide, wherein the pull strip 174 and the pull tab 174 are about 0.375 inches wide. These dimensions can be varied depending upon the size and type of food product.

In the second exemplary embodiment illustrated in FIGS. 5-8, the separable raised platform 200 is convertible from a joined configuration to a separated configuration of first and second raised platform sections 202, 204. The separable raised platform 200 includes a support 206 for the food product 108 during microwave heating having a susceptor 208 disposed thereon. In the illustrated form, the support 206 is generally rectangular having a pair of generally parallel side edges 210 and a pair of generally parallel end edges 212 forming a periphery. Legs 214 depend from the support periphery to elevate the support 206 and the susceptor 208, and thus the food product 108, above the floor or tray of the microwave during microwave heating.

Turning now to more of the details of the legs 214, opposing side walls 224 depend from the pair of side edges 210 and opposing end walls 226 depend from the pair of end edges 212. Each of the side walls 224 and the end walls 226 is rectangular, having a top edge 228, an opposite bottom edge 230, and a pair of side edges 232. Specifically, the top edges 228 of the side walls 224 connect to the side edges 210 of the support and the top edges 128 of the end walls 226 connect to the end edges 212 of the support 206. The end walls 226 join to the side walls 224 at four outside corners 234, where they are secured together to hold the separable raised platform 200 in an elevated position. The side walls 224 each have a pair of tabs 136 depending off of the pair of side edges 232. The tabs are then adhered to the end walls 226, such as to an inside of the end walls 226 to preserve the aesthetics of the separable raised platform 200 and prevent the tabs from becoming snared and separated from the end walls 226. In use, however, the side walls 224 could also secure to the end walls 226 by mechanical methods, such as a locking tab inserted into a slot or a tongue-and-groove mechanism. It will be understood that the end walls 226 could alternatively be secured to the side walls 224 by similar methods.

An area of weakness 238 is disposed across the end walls 226 and the support 206 of the separable raised platform 200, dividing the separable raised platform into the first and second raised platform sections 202, 204. In addition to dividing the separable raised platform 200 into the first and second raised platform sections 202, 204, the area of weakness 238 also partially defines first and second supporting legs 240, 242. In the illustrated form, the area of weakness 238 includes perforations in the form of small cuts, however, other suitable areas of weakness 238 could be utilized, such as, scores (laser or mechanical), a pull strip, a notch, offset partial cuts, or other patterns, shapes, and sizes of perforations.

The area of weakness 238 includes five segments. In the illustrated form, a first segment 138A extends across one of the end walls 226 offset from the center of the end wall 226 in the direction of one of the sidewalls 224, such as by a distance generally half of the height of the end walls 226. The first segment 238A extends across the one of the end walls 226 at a direction generally perpendicular with the bottom edge 230 of the end wall 226. A second segment 238B connects to the first segment 238A at the top edge 228 of the end wall 226 and extends across a portion of the support 206 generally in line with the first segment 238A. A third segment 238C extends across the end wall 226 opposite from the first segment 238A in a direction generally perpendicular with the bottom edge 230 of the end wall 226. The third segment 238C is offset from the center of the end wall 226 in the direction opposite the offset of the first segment 238A, such as by a distance generally half of the height of the end walls 226. A fourth segment 238D connects to the third segment 238C at the top edge 228 of the end wall 226 and extends across a portion of the support 206 generally in line with the third segment 238C. A fifth segment 238E connects the ends of the second and fourth segments 238B, 238D opposite the ends on the top edge 228 of the end walls 226, such as in a direction generally perpendicular with both the second and fourth segments 238B, 238D.

It will be understood, however, that the orientations of the segments of the area of weakness 238 could extend at directions other than perpendicular and parallel with the edges 210, 212 of the support 206. Additionally, the first and third segments 238A, 238C could be disposed across other areas of the end walls 226, such as the center of the end walls 226, which would then require additional segments to connect the first and third segments 238A, 238C with the offset second and fourth segments 238B, 238D.

In the illustrated form, the separable raised platform 200 further includes a first area of weakness 244. The first area of weakness 244 connects to the first and second segments 238A, 238B of the area of weakness 238 at the top edge 228 of the end wall 226. The first area of weakness 244 extends along the top edge 228 of the end wall 225 in a direction opposite the offset of the first segment 238A until the first area of weakness 244 is generally aligned with the fourth segment 238D. A first fold line 246 extends from this point of the first area of weakness 244 and connects to the fourth segment 238D. In the illustrated form, the first supporting leg 240 is generally rectangular and has sides defined by the first area of weakness 244, the second segment 238B, the fifth segment 238E, and the first fold line 246.

A second area of weakness 248 connects to the third and fourth segments 238C, 238D of the area of weakness 238 at the top edge 228 of the end wall 226. The second area of weakness 248 extends along the top edge 228 of the end wall 225 in a direction opposite the offset of the third segment 238C until the second area of weakness 248 is generally aligned with the second segment 238B. A second fold line 250 extends from this point of the second area of weakness 248 and connects to the second segment 238B. In the illustrated form, the second supporting leg 242 is generally rectangular and has sides defined by the second area of weakness 248, the fourth segment 238D, the fifth segment 238E, and the second fold line 248.

The first and second areas of weakness 246, 248 are illustrated as cuts through the separable raised platform 200, however, other suitable areas of weakness may be utilized, such as perforations and scoring (lasing and mechanical), offset partial cuts, or the like in any desirable size, pattern, and configuration. By one approach, the first and second fold lines 246, 250 may have vent slits formed therein.

So disposed, dividing the area of weakness 238 separates the separable raised platform 200 into the separated configuration, producing the first and second raised platform sections 202, 204. The first raised platform section 202 has a first part 252 of the support 206 and the second raised platform section 204 has a second part 254 of the support 206. Additionally, when the separable raised platform 200 is separated, the first and second raised platform sections 202, 204 each have a free edge 256 adjacent to the separated area of weakness 238. In order to support the free edge 256 during microwave heating of the food product 108, the first and second support legs 240, 242 are configured to fold about the first and second fold lines 246, 250 respectively to an erected position generally perpendicular with the first and second parts 252, 254 of the support 206. When the first and second support legs 240, 242 are folded down to this position, they effectively support and elevate the free edge 256 and portions of the support 206 proximate thereto, including when a food product is disposed thereon during microwave heating. A tab and slot may be provided to secure the first and second support legs 240, 242 in their folded position. For example, the first and second support legs 240, 242 may each have a tab that is provided in the associated legs 226, 228 that is separable therefrom (such as via an area of weakness) and insertable into a slot formed in each of the legs 226, 228.

By one approach, the susceptor 208 does not extend over the area of weakness 238. In this approach, the susceptor 208 would extend only to an area adjacent the area of weakness 238, such as on the support 208 or on the end walls. This configuration prevents edges or corners of metallic materials in the susceptor 208 from being exposed as a result of separating the area of weakness 238, also preventing the metallic edges or corners from arcing during microwave heating.

To provide for the ventilation of the food product 108 during microwave heating, the support 206 and susceptor 208 have a plurality of vent slits 216 and holes 218 therethrough. The vent slits 216, as illustrated, are aligned in a series of five generally parallel rows 120, each row having a number of spaced slits 216. The holes 218 are provided in corner portions of the support 206 and in a cluster in the center of the support 206 including four smaller holes 218 and a large center hole 222. This cluster is provided to ventilate the center a large food product disposed over a majority of the support 206 during microwave heating. Additional vent slits 216 are provided on the side edges 210 and the end edges 212 of the support 206. It will be understood, however, that other combinations, quantities, and patterns of the slits 216 and/or holes 218 can be utilized to optimize the ventilation of the specific food product 108 for which the separable raised platform 200 is manufactured.

As discussed above with reference to FIG. 4 for the first embodiment, the separable raised platform 200 can be utilized as one part of the food product packaging. The food product packaging can include an outer carton 178, the food product or products 108 sealed within inner film wrappers 180, and the separable raised platform 200. In this embodiment, the support 206 and the legs 214 of the separable raised platform 200 form a cavity. In order to minimize the packaging costs of the outer carton 178, this cavity can be utilized to hold the food product or products 108 within the outer carton 178 during storage and transportation. Preferably, the height of the end walls 226 and the side walls 224 of the separable raised platform 200 extend beyond the height of the food product or products 108 so that the food products 108 are confined within the limits of the cavity. This configuration provides additional protection for the food products 108 against damage caused during storage, transportation, and handling. The food product or products 108 are wrapped within the inner film wrappers 180 as is known for preservation and protection. The food products 108 are then placed within the cavity of the separable raised platform 200 and then the separable raised platform 200 storing the food products therein is inserted into the outer carton 178.

So configured, the separable raised platform 200 is convertible from the joined configuration to the separated configuration. The joined configuration can be utilized to cook a large or multiple food products at a single time and the separated configuration can be utilized to cook a portion of the large food product or single food products at different times. The separable raised platform 200 further provides support for the free edge 256 of the first and second raised platform sections 202, 204 adjacent the area of weakness 238 when in the separated configuration.

In accordance with one example of the second embodiment of the separable raised platform 200, the support 206 may be about 6.5 inches long by 6.5 inches wide, where the first and second parts 252, 254 of the support are about 6.5 inches long by about 2.75 inches wide with the first and second support legs 240, 242, each measuring about 1 inch, folded down for support. The legs 214 may have a height of about 1 inch. However, these dimensions can be varied depending upon the size and type of food product.

In the third exemplary embodiment illustrated in FIGS. 9-12, the separable raised platform 300 is convertible from a joined configuration to a separated configuration of first and second raised platform sections 302, 304. The separable raised platform 300 includes a support 306 for the food product 108 during microwave heating having a susceptor 308 disposed thereon. In the illustrated form, the support 306 is generally rectangular having a pair of generally parallel side edges 310 and a pair of generally parallel end edges 312 forming a periphery. Legs 314 depend from the support periphery to elevate the support 306 and the susceptor 308, and thus the food product 108, above the floor or tray of the microwave during microwave heating.

Turning now to details of the legs 314, opposing side walls 324 depend from the pair of side edges 310 and opposing end walls 326 depend from the pair of end edges 312. Each of the side walls 324 and the end walls 326 is rectangular, having a top edge 328, an opposite bottom edge 330, and a pair of side edges 332. Specifically, the top edges 328 of the side walls 324 connect to the side edges 310 of the support and the top edges 328 of the end walls 326 connect to the end edges 312 of the support 306. The end walls 326 join to the side walls 324 at four outside corners 334, where they are secured together to hold the separable raised platform 300 in an elevated position. The side walls 324 each have a pair of tabs 336 depending off of the pair of side edges 332. The tabs 336 are then adhered to the end walls 326, such as to an inside of the end walls 326 to preserve the aesthetics of the separable raised platform 300 and prevent the tabs 336 from becoming snared and separated from the end walls 326. In use, however, the side walls 324 could also secure to the end walls 326 by mechanical methods, such as a locking tab inserted into a slot or a tongue-and-groove mechanism. It will be understood that the end walls 326 could alternatively be secured to the side walls 324 by similar methods.

An area of weakness 338 is disposed across the end walls 326 and the support 306 of the separable raised platform 300, dividing the separable raised platform into the first and second raised platform sections 302, 304. In addition to dividing the separable raised platform 300 into the first and second raised platform sections 302, 304, the area of weakness 238 also partially defines first and second support legs 340, 342. In the illustrated form, the area of weakness 338 includes perforations in the form of small cuts, however, other suitable areas of weakness 338 could be utilized, such as, scores (laser or mechanical), a pull strip, a notch, offset partial cuts, or other patterns, shapes, and sizes of perforations.

The area of weakness 338 includes three segments. In the illustrated form, a first segment 338A extends across one of the end walls 226 generally aligned with the center of the end wall 326 and in a direction generally perpendicular with the bottom edge 330 of the end wall 326. A second segment 338B extends across the end wall 326 opposite from the first segment 338A generally aligned with the center of the end wall 326 and in a direction generally perpendicular with the bottom edge 330 of the end wall 326. The third segment 138C connects to the first and second segments 338A, 338B at the top edges 328 of the end walls 326 forming the continuous area of weakness 338 generally bisecting the separable raised susceptor 300.

It will be understood, however, that the orientations of the segments of the area of weakness 338 could extend at directions other than perpendicular with the edges 310, 312 of the support 306. Additionally, the first and second segments 338A, 338B could be disposed across other areas of the end walls 326.

In the illustrated form, the separable raised platform 300 further includes first and second areas of weakness 344, 346. The first area of weakness 344 is disposed on the top edge 328 of the end wall 326 and is generally centered on the connection of the first and third segments 338A, 338C of the area of weakness 338. By one approach, the first area of weakness 344 extends from the connection of the first and third segments 338A, 338C in both directions approximately 0.5 to 2 inches and preferably, about 1 inch. The second area of weakness 346 is disposed on the top edge 328 of the end wall 326 opposite the first area of weakness 344 and is generally centered on the connection of the second and third segments 338B, 338C of the area of weakness 338. By one approach, the second area of weakness extends from the connection of the second and third segments 338B, 338C in both directions approximately 0.5 to 2 inches, and preferably, about 1 inch.

The first and second areas of weakness 344, 346 are illustrated as cuts through the separable raised platform 300, however, other suitable areas of weakness may be utilized, such as perforations and scoring (lasing and mechanical), offset partial cuts, or the like in any desirable size, pattern, and configuration.

The first raised platform section 302 includes first fold lines 348 disposed across the end walls 326 in a generally aligned orientation. In the illustrated form, the first fold lines 348 extend from the bottom edge 330 of the end walls 326 in a perpendicular orientation and connect to ends of the first and second areas of weakness 344, 346. The first support leg 340 includes two generally rectangular wall segments 350. One of the wall segments 350 includes sides defined by the bottom edge 330 of the end wall 326, the first segment 338A, the first area of weakness 344, and one of the first fold lines 348. The other one of the wall segments 350 includes sides defined by the bottom edge 330 of the end wall 326, the second segment 338B, the second area of weakness 346, and the other of the first fold lines 348. So configured, the wall segments 350 are inwardly pivotable over the first fold lines 348 between a first position in the joined configuration where the wall segments 350 are connected on two edges by the area of weakness 338 and the first and second areas of weakness 344, 346 and a second position in the separated configuration inwardly oriented and in a generally perpendicular supporting relationship with the support 306.

The second raised platform section 304 includes second fold lines 352 disposed across the end walls 326 in a generally aligned orientation. In the illustrated form, the second fold lines 352 extend from the bottom edge 330 of the end walls 326 in a perpendicular orientation and connect to ends of the first and second areas of weakness 344, 346 opposite of the first fold lines 348. The second support leg 342 includes two generally rectangular wall segments 354. One of the wall segments 354 includes sides defined by the bottom edge 330 of the end wall 326, the first segment 338A, the first area of weakness 344, and one of the second fold lines 352. The other one of the wall segments 354 includes sides defined by the bottom edge 330 of the end wall 326, the second segment 338B, the second area of weakness 346, and the other of the second fold lines 352. So configured, the wall segments 354 are inwardly pivotable over the second fold lines 352 between a first position in the joined configuration where the wall segments 354 are connected on two edges by the area of weakness 338 and the first and second areas of weakness 344, 346 and a second position in the separated configuration inwardly oriented and in a generally perpendicular supporting relationship with the support 306. By one approach, the first and second fold lines 348, 352 may have vent slits 316 formed therein.

So disposed, dividing the area of weakness 338 separates the separable raised platform 300 into the separated configuration, producing the first and second raised platform sections 302, 304. The first raised platform section 302 has a first part 356 of the support 306 and the second raised platform section 304 has a second part 358 of the support 306. Additionally, when the separable raised platform 300 is separated, the first and second raised platform sections 302, 304 each have a free edge 360 adjacent to the area of weakness 338 when separated. In order to support the free edge 360 during microwave heating of the food product 108, the first and second support legs 340, 342 are configured to fold inward about the first and second fold lines 348, 352 respectively to an erected position generally perpendicular with and underneath the first and second parts 356, 358 of the support 306. When the first and second support legs 340, 342 are folded inward to this position, they effectively support and elevate the free edge 360 of the first and second raised platform sections 302, 304 and portions of the support 306 proximate thereto, as well as any food product thereon during microwave heating. The support legs 340, 342 may be securable to the support 306, such as by using a tab and slot connection. For example, the support legs 340, 342 may be connected to a tab integral with the support 306 but removable from the support 306 via perforations. That tab can then be inserted into a slot in the support 306 after the support legs 340, 342 have been folded therebeneath. A like arrangement can be used with both platform sections 302, 304.

By one approach, the susceptor 308 does not extend over the area of weakness 338. In this approach, the susceptor 308 would extend only to an area adjacent the area of weakness 338, such as on the support 308 or on the end walls 336 if the susceptor 308. This configuration prevents edges or corners of metallic materials in the susceptor 308 from being exposed as a result of separating the area of weakness 338, preventing the metallic edges or corners from arcing during microwave heating.

To provide for the ventilation of the food product 108 during microwave heating, the support 306 and susceptor 308 have a plurality of vent slits 316 and holes 318 therethrough. The vent slits 316, as illustrated, are aligned in a series of five generally parallel rows 320, each row having a number of spaced slits 316. The holes 318 are provided in corner portions of the support 206 and in a cluster in the center of the support 306 including four smaller holes 318 and a large center hole 322. This cluster is provided to ventilate the center a large food product disposed over a majority of the support 306 during microwave heating. Additional vent slits 316 are provided on the side edges 310 and the end edges 312 of the support 306. It will be understood, however, that other combinations, quantities, and patterns of the slits 316 and/or holes 318 can be utilized to optimize the ventilation of the specific food product 108 for which the separable raised platform 300 is manufactured.

As discussed above with reference to FIG. 4 for the first embodiment, the separable raised platform 300 can be utilized as one part of the food product packaging. The food product packaging can include an outer carton 178, the food product or products 108 sealed within inner film wrappers 180, and the separable raised platform 300. In this embodiment, the support 306 and the legs 314 of the separable raised platform 300 form a cavity. In order to minimize the packaging costs of the outer carton 178, this cavity can be utilized to hold the food product or products 108 within the outer carton 178 during storage and transportation. Preferably, the height of the end walls 326 and the side walls 324 of the separable raised platform 300 extend beyond the height of the food product or products 108 so that the food products 108 are confined within the limits of the cavity. This configuration provides additional protection for the food products 108 against damage caused during storage, transportation, and handling. The food product or products 108 are wrapped within the inner film wrappers 180 as is known for preservation and protection. The food products 108 are then placed within the cavity of the separable raised platform 300 and then the separable raised platform 300 storing the food products therein is inserted into the outer carton 178.

So configured, the separable raised platform 300 is convertible from the joined configuration to the separated configuration. The joined configuration can be utilized to cook a large or multiple food products at a single time and the separated configuration can be utilized to cook a portion of the large food product or single food products at different times. The separable raised platform 300 further provides support for the free edge 356 of the first and second raised platform sections 302, 304 adjacent the area of weakness 338 when in the separated configuration.

In accordance with one example of the third embodiment of the separable raised platform 300, the support 306 may be about 6.5 inches long by 6.5 inches wide, where the first and second parts 356, 358 of the support are about 6.5 inches long by about 3.25 inches wide with the first and second support legs 340, 342, each segment 350, 354 measuring about 1 inch long, folded inward for support. The legs 314 may have a height of about 1 inch. These dimensions can be varied depending upon the size and shape of the food product.

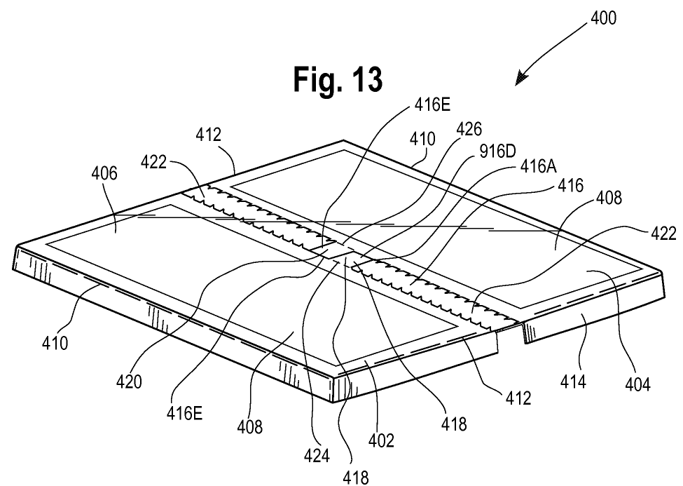

In a fourth exemplary embodiment illustrated in FIGS. 13-15, the separable raised platform 400 is convertible from a joined configuration to a separated configuration of first and second raised platform sections 402, 404. The separable raised platform 400 includes a support 406 for the food product 108 during microwave heating having a susceptor 408 disposed thereon. In the illustrated form, the support 406 is generally rectangular having a pair of generally parallel side edges 410 and a pair of generally parallel end edges 412 forming a periphery. Legs 414 depend from the support periphery to elevate the support 406 and the susceptor 408, and thus the food product 108, above the floor or tray of the microwave during microwave heating.

An area of weakness 416 is disposed across the support 406 of the separable raised platform 400, dividing the separable raised platform 400 into the first and second raised platform sections 402, 404. In addition, the area of weakness 416 also partially defines first and second supporting legs 418, 420. The area of weakness 416 includes five segments. Three segments 416A, 416B, and 416C extend between the first and second raised platform sections 402, 404 forming sides of the first and second supporting legs 418, 420. Preferably, the three segments 416A, 416B, and 416C are approximately equal in length to the height of the separable raised platform 400. Fourth and fifth segments 416D and 416E connect adjacent pairs of the three segments 416A, 416B, and 416C, respectively, forming end edges of the first and second supporting legs 418, 420 configured to rest on the floor of the microwave when the separable raised platform 400 is in an erected configuration.

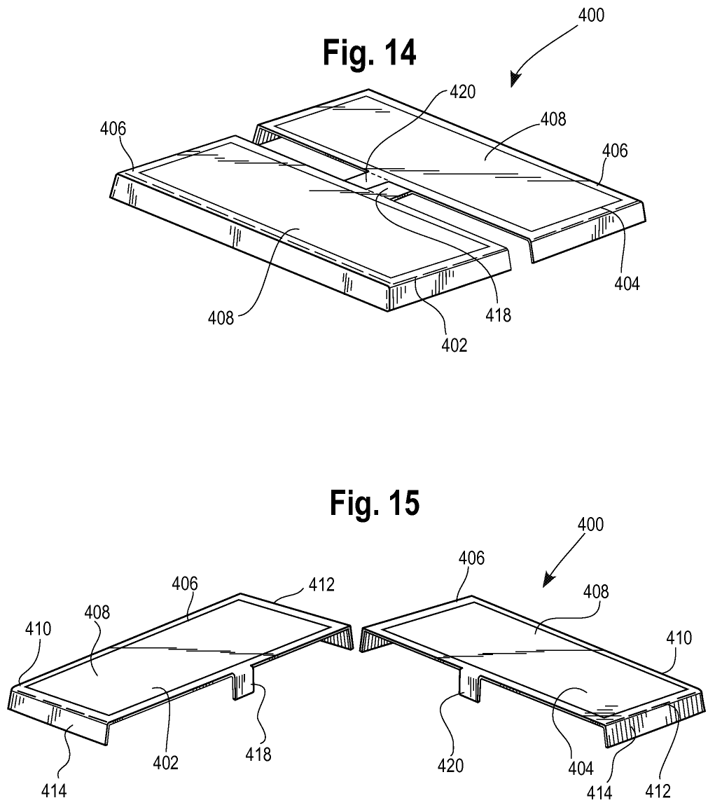

The area of weakness 416 further includes a pattern of perforations forming pull tab strips 422. The pull tab strips 422 extend between the segments 416A and 416C, respectively, and the side edges 410 of the support 406. The pull tab strips 422 are configured to be pulled and removed by a user, partially separating the separable raised platform 400, as shown in FIG. 14. After the pull tab strips 422 are removed, the segments 416B, 416D, and 416E are separated and the first and second supporting legs 418, 420 fold down over first and second fold lines 424, 426 to a position generally perpendicular with the support. In this position, the first and second supporting legs 418, 420 support an edge portion of the support in an elevated configuration.

In the illustrated form, the area of weakness 416 includes perforations in the form of small cuts and pull strips, however, other suitable areas of weakness could be utilized, such as, scores (laser or mechanical), a notch, offset partial cuts, or other patterns, shapes, and sizes of perforations.

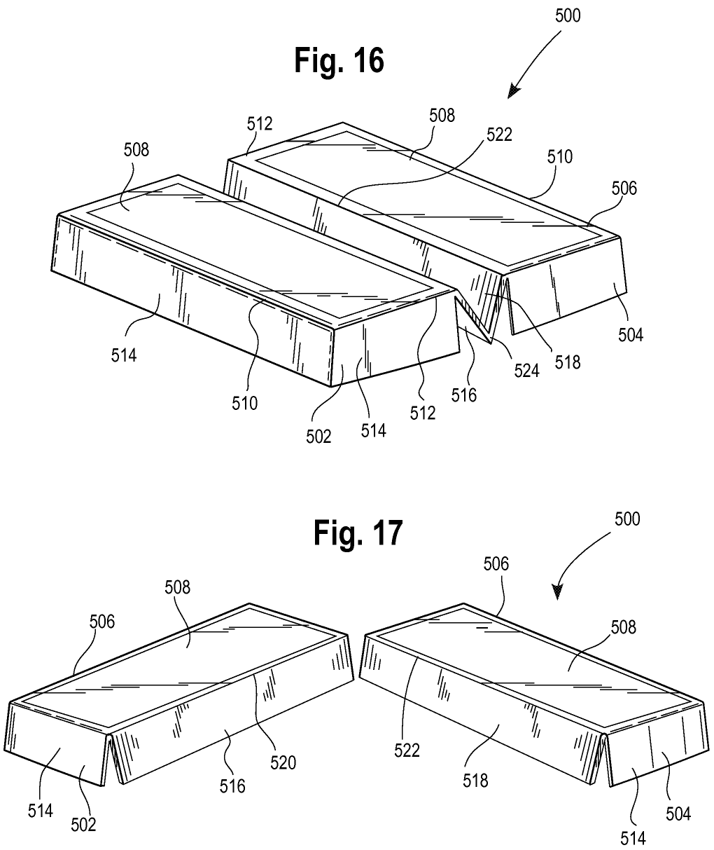

In a fifth exemplary embodiment illustrated in FIGS. 16-17, the separable raised platform 500 is convertible from a joined configuration to a separated configuration of first and second raised platform sections 502, 504. The separable raised platform 500 could alternatively include three or more raised platform sections. The separable raised platform 500 includes a support 506 for the food product 108 during microwave heating having a susceptor 508 disposed thereon. In the illustrated form, the support 506 is generally rectangular having a pair of generally parallel side edges 510 and a pair of generally parallel end edges 512 forming a periphery. Legs 514 depend from the support periphery to elevate the support 506 and the susceptor 508, and thus the food product 108, above the floor or tray of the microwave during microwave heating.

The separable raised platform 500 further includes first and second support legs 516, 518. The first and second support legs 516, 518 extend between and connect the first and second raised platform sections 502, 504. Preferably, the first and second support legs 516, 518 each span the width of the support 506. The first and second support legs connect to the support 506 by first and second fold lines 520, 522 respectively and are divided by an area of weakness 524. By being unattached to adjacent portions of the legs 514, the first and second support legs 516, 518 are pivotable over the first and second fold lines 520, 522 and the area of weakness 524, allowing the separable raised platform 500 a range of widths between a fully extended position and a fully folded position.

The support legs 516, 518, however, may be securable to the support 506, such as by using a tab and slot connection. For example, the support legs 516, 518 may include a tab protruding from one or more side edges. That tab can then be inserted into a slot in the support 506 or legs 514 after the support legs 516, 518 have been folded therebeneath. A like arrangement can be used with both platform sections 502, 504.

In an alternative form, the first and second raised platform sections 502, 504 can be raised to different elevations. In this form, the first support leg 516 and the legs 514 of the first raised platform section 502 would have a substantially equal height. Similarly, the height of the second support leg 518 and the legs 514 of the second raised platform section 504 would be substantially equal and different from the first raised platform section 502.

In the illustrated form, the area of weakness 524 includes perforations in the form of small cuts, however, other suitable areas of weakness could be utilized, such as, scores (laser or mechanical), a pull strip, a notch, offset partial cuts, or other patterns, shapes, and sizes of perforations.

So configured, the separable raised platform 500 can be converted from a joined configuration to a separated configuration by separating the area of weakness 524. The first and second support legs 516, 518 are then folded down over the first and second fold lines 520, 522 to positions generally perpendicular with the support 506. In this position, the first and second support legs 516, 518 support and maintain an edge portion support 506 in an elevated configuration.

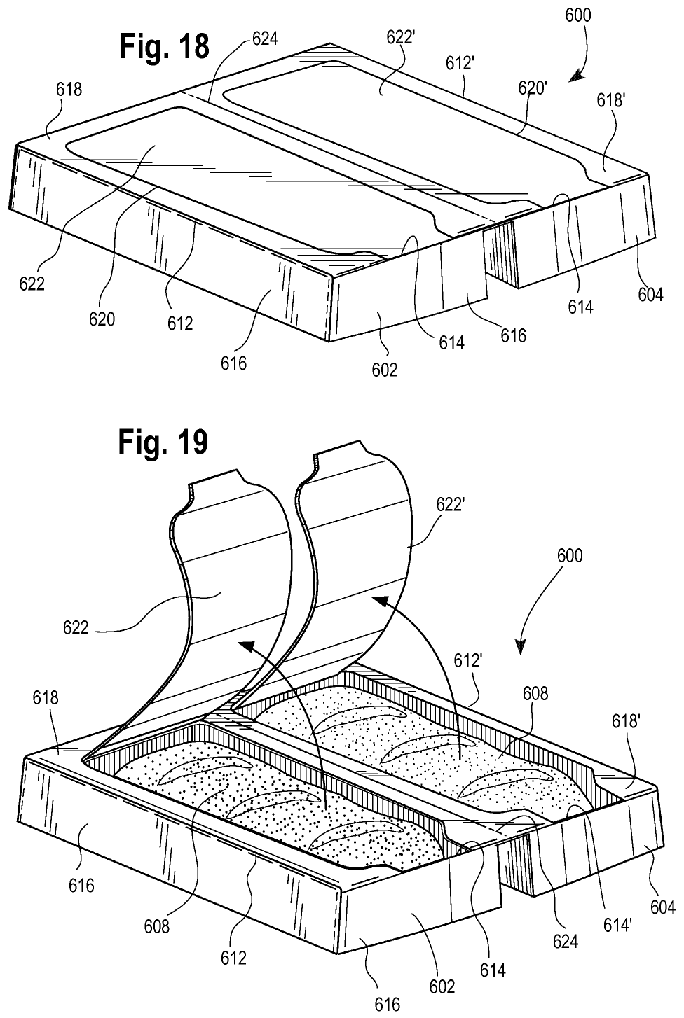

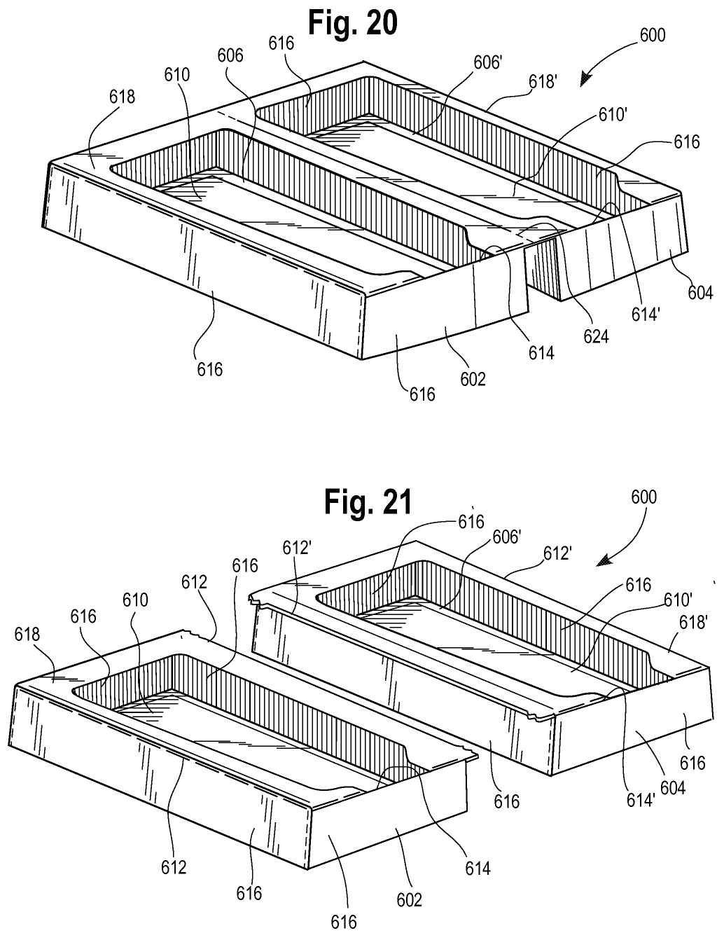

In a sixth exemplary embodiment illustrated in FIGS. 18-21, the separable platform 600 is convertible from a joined configuration to a separated configuration of first and second platform sections 602, 604. The separable platform 600 could alternatively include three or more platform sections. Each platform section 602, 604 includes a support 606, 606′ for a food product 608 during microwave heating having a susceptor 610, 610′ disposed thereon. In the illustrated form, the support 606, 606′ is generally rectangular having a pair of generally parallel side edges 612, 612′ and a pair of generally parallel end edges 614, 614′ forming a periphery. Walls 616 extend from the support periphery and connect to a top 618, 618′. The susceptor 610, 610′ may also extend onto any portion of the walls 616 and/or the top 618, 618′ to provide greater susceptor contact area to the food product 608.

The top 618, 618′ may further include an area of weakness 620, 620′ defining a removable portion 622, 622′. Removing the removable portion 622, 622′ provides access to an interior of the platform 600, such as to access the food product 608. The removable portion 622, 622′ may be left on during microwave cooking of the food product 608, or alternatively, it may be removed, such as to remove the food product 608 from an inner film wrapper prior to cooking.

The first and second platform sections 602, 604 are connected by an area of weakness 624. In the illustrated form, the area of weakness 624 includes a combination of perforations and a cut extending a majority of the width of the top 618, 618′. It will be understood, however, that other suitable areas of weakness or combinations could be utilized, such as, scores (laser or mechanical), a pull strip, a notch, offset partial cuts, or other patterns, shapes, and sizes of perforations.

In another form, a susceptor can be disposed on the bottom of the first and second platform sections 602, 604. So configured, the first and second platform sections 602, 604 can be flipped over to provide an elevated surface for microwave heating of the food product 108. Alternatively, a susceptor can be disposed on the inside surface of the removable portions 622, 622′. In this configuration, an end of the removable portions 622, 622′ can be attached to a middle region of the legs 616 to wrap around and lay across a bottom of the first and second platform sections 602, 604. So configured, the removable portions 622, 622′ can be wrapped around the first and second platform sections 602, 604 to provide elevated microwave heating of the food product.

In yet another form, a susceptor can be disposed on a top surface of the removable portions 622, 622′. In this form, the removable portions 622, 622′ can be partially attached to the top 618, 618′, and after the removable portions 622, 622′ are partially separated, the removable portions 622, 622′ can be returned to the original position. So configured, the food product 108 can be removed from the first and second platform sections 602, 604, the removable portions 622, 622′ can be replaced, and the food product can be heated in an elevated position while supported by the removable portions 622, 622′.

So configured, the platform 600 is provided in a joined configuration and can be utilized to heat two food products 608 concurrently. If desired, however, a user can separate the area of weakness 624 dividing the platform 600 into the first and second platform sections 602, 604, allowing the two food products 608 to be heated separately.

In the illustrated forms, the support is generally rectangular having four sides. In use, however, the support may take any suitable shape, including, for example, curvilinear shapes, such as generally circular or elliptical, or shapes with linear sides, such as a triangle, a quadrilateral, a hexagon, an octagon, or other regular or irregular polygons. The susceptor may be imprinted onto the support or, alternatively, may be secured to the support by any suitable method, such as adhesive. The susceptor may be of a type that expands upon heating to better conform to an adjacent portion of the food product, which can be advantageous if the adjacent portion of the food product has surface irregularities or is slightly curved, and thus not entirely planer. One type of expanding susceptor material is made and sold by Graphics Packaging, Inc. under the product name QuiltWave™. As the susceptor expands, it can at least partially contact some of the non-planar portions of the adjacent portion of a food product resulting in a more desirable food product.

The separable raised platforms disclosed herein are particularly suitable for use with food products having an outer dough-based portion in contact with the susceptor surface. For example, the separable raised platforms can be used in microwave heating of a food product that comprises French bread having toppings, such a pizza toppings, and an outer crust on the bottom. Other examples of food products having dough-based portions include sandwiches, calzones, pitas, pizzas, strombolis and other such dough-enrobed or dough-based food products. The dough-based portions of the food products can be in various forms, such as cooked, par-baked, raw, ready-to-heat, ready-to-eat, proofed or unproofed dough which is suitable for being cooked, browned, and/or crisped.

Preferably, though not necessarily, the separable raised platforms are formed from a single unitary blank of material, such as paperboard. Forming the separable raised platforms from a single unitary blank can eliminate the need for separately attaching the legs to the support. Alternatively, the separable raised platforms can be pressed trays.

The drawings and the foregoing descriptions are not intended to represent the only forms of the separable raised platform in regards to the details of construction. Changes in form and in proportion of parts, as well as the substitution of equivalents, are contemplated as circumstances may suggest or render expedient.

What is claimed is:

1. A raised platform for microwave heating of a food product selectively separable into a plurality of independent raised platform portions, the raised platform comprising:
a support for supporting a food product during microwave heating thereof;
a susceptor disposed on the majority of the support for conducting heat to a food product thereon during microwave heating;
legs depending from the support to elevate the support surface during microwave heating; and
an area of weakness joining first and second raised platform portions, wherein:
the first raised platform portion including a first portion of the support, a first portion of the legs depending from the periphery of the first portion of the support, and a first support leg configured to support an edge of the first raised platform portion adjacent the area of weakness, and
the second raised platform portion including a second portion of the support, a second portion of the legs depending from the periphery of the second portion of the support, and a second support leg configured to support an edge of the second raised platform portion adjacent the area of weakness.

2. The raised platform of claim 1, wherein the area of weakness is disposed between the first and second support legs.

3. The raised platform of claim 2, wherein the first and second support legs are unattached to adjacent portions of the legs.

4. The raised platform of claim 1, wherein:
the first support leg connected to the first portion of the support via a first fold, the first support leg pivotable about the first fold between a first position generally planar with the first portion of the support and a second position generally perpendicular with the first portion of the support; and
the second support leg connected to the second portion of the support via a second fold, the second supporting leg pivotable about the second fold between a first position generally planar with the second portion of the support and a second position generally perpendicular with the second portion of the support.

5. The raised platform of claim 4, wherein the area of weakness further comprises a pattern of perforations defining pull tab strips extending between the first and second support legs and adjacent edges of the support.

6. The raised platform of claim 1, wherein a connecting panel spans between the first and second support legs at end portions of the legs opposite the first and second portions of the support and the area of weakness is a pattern of perforations in the connecting panel defining a pull tab strip.

7. The raised platform of claim 1, wherein the support is continuous and generally planar and the area of weakness is formed in the support.

8. The raised platform of claim 7, further comprising a plurality of secondary areas of weakness each extending transversely from the area of weakness and defining edges of the legs, and wherein the area of weakness defines at least one other edge of the legs adjacent the secondary areas of weakness.

9. The raised platform of claim 8, wherein:
the area of weakness and the plurality of secondary areas of weakness are separable to form the first support leg, the first support leg foldable to a generally perpendicular supporting relationship with the first platform portion to support the edge of the first raised platform portion adjacent the area of weakness; and
the area of weakness and the plurality of secondary areas of weakness are separable to form the second support leg, the second support leg foldable to a generally perpendicular supporting relationship with the second platform portion to support the edge of the second raised platform portion adjacent the area of weakness.

10. The raised platform of claim 8, wherein:
the first support leg comprised of two leg segments on opposite sides of the first raised platform portion, the two leg segments connected to legs depending from opposite sides of the periphery of the support via first folds, the first support leg pivotable between a first position generally planar with the legs and a second position generally perpendicular with the legs and the first portion of the support; and
the second support leg comprised of two leg segments on opposite sides of the second raised platform portion, the two leg segments connected to legs depending from opposite sides of the periphery of the support via second folds, the second support leg pivotable between a first position generally planar with the legs and a second position generally perpendicular with the legs and the second portion of the support.

11. The raised platform of claim 1, further comprising:
first and second fold lines; and
first and second areas of weakness, wherein:
the support being generally rectangular;
the legs depending from all sides of the support to elevate the support surface during microwave heating;
the area of weakness continuously extending from a first side of the raised platform to a second side of the raised platform opposite the first side, the area of weakness comprising:
a first segment extending across a portion of the support to the first side and across the leg depending from the first side;
a second segment extending across a portion of the support to the second side and across the leg depending from the second side, the second segment misaligned from the first segment; and
a third segment connecting ends of the first and second segments disposed on the support;
the first area of weakness extending transversely from the first segment adjacent the first side of the raised platform;
the first fold line disposed on the support adjacent the first area of weakness on one side and the third segment on an opposite side;
the first support leg having four sides defined by the first area of weakness, the first segment, the third segment, and the first fold line, the first support leg foldable downward to support an edge of the first raised platform portion adjacent the area of weakness;
the second area of weakness extending transversely from the second segment adjacent the second side of the raised platform;
the second fold line disposed on the support adjacent the second area of weakness on one side and the third segment on an opposite side;
the second support leg having four sides defined by the second area of weakness, the second segment, the third segment, and the second fold line, the second support leg foldable downward to support an edge of the second raised platform portion adjacent the area of weakness.

12. The raised platform of claim 1, further comprising:
first and second fold lines; and
first and second areas of weakness, wherein:
the support is generally rectangular;
the legs depend from all sides of the support to elevate the support surface during microwave heating;
the area of weakness continuously extends from a first side of the raised platform to a second side of the raised platform opposite the first side bisecting the raised platform into the first and second raised platform portions;
the first areas of weakness extend on edges of the first and second sides of the first raised platform portion, each transversely connecting to the area of weakness;
the first fold lines extending across the legs depending from the first and second sides of the support and being adjacent the first areas of weakness;
the first support leg comprising two leg segments, each having four sides, three of the sides defined by the first areas of weakness, the area of weakness, and the first fold lines, the first support leg foldable inward to support an edge of the first raised platform portion adjacent the area of weakness;
the second areas of weakness extend on edges of the first and second sides of the second raised platform portion, each transversely connecting to the area of weakness;
the second fold lines extending across the legs depending from the first and second sides of the support and being adjacent the second areas of weakness;
the second support leg comprising two leg segments, each having four sides, three of the sides defined by the second areas of weakness, the area of weakness, and the second fold lines, the second support leg foldable inward to support an edge of the second raised platform portion adjacent the area of weakness.

13. A raised platform for microwave heating of a food product convertible from a joined configuration to a separated configuration to permit microwave heating of separate food products at different times, the raised platform comprising:
first and second raised platform portions each having:
a support surface for supporting a food product during microwave heating thereof,
a susceptor disposed on the majority of the support surface for conducting heat to a food product thereon during microwave heating, and
legs supporting edge portions adjacent a plurality of sides of the support surface including support legs supporting edge portions adjacent a side of the support surface adjacent to the support surface of the other of the first and second raised platform portions to elevate the support surface during microwave heating when the raised platform is in its separated configuration; and
an area of weakness joining the first and second raised platform portions when the raised platform is in the joined configuration and separable to convert the raised platform from the joined configuration to the separated configuration.

14. The raised platform of claim 13 wherein the area of weakness joins the support legs of the first and second raised platform portions.

15. The raised platform of claim 13 wherein the first and second raised platform portions each have a free edge initially without support in the separated configuration, and wherein the support legs are foldable to support the free edge.

16. The raised platform of claim 13 wherein the support legs of the first and second raised platform portions are movable between a first position in the joined configuration releasably connected to the other of the first and second raised platform portions by the area of weakness and a second position in the separated configuration folded to support the edge portions adjacent the side of the support surface adjacent to the support surface of the other of the first and second raised platform portions to elevate the support surface during microwave heating.

17. The raised platform of claim 16 further comprising a plurality of secondary areas of weakness extending from the area of weakness, wherein the plurality of secondary areas of weakness connect the support legs to the first and second raised platform portions in the joined configuration and form an edge of the support legs in the separated configuration.

18. The raised platform of claim 16 wherein:
the support legs each further comprise fold lines, wherein the support legs are pivotable over the fold lines between the first position and the second position generally perpendicular with the support surface for supporting a food product in an elevated position during microwave heating.

19. The raised platform of claim 18 wherein the fold lines are disposed across portions of the support surface.

20. The raised platform of claim 18 wherein the first and second fold lines are disposed across the legs.

21. A raised platform for microwave heating of a food product selectively separable into a plurality of independent raised platform portions, the raised platform comprising:
a support for supporting a food product during microwave heating thereof;
a susceptor disposed on the majority of the support for conducting heat to a food product thereon during microwave heating;
legs depending from the support to elevate the support surface during microwave heating; and
an area of weakness joining first and second raised platform portions, each of the first and second raised platform portions including a portion of the support and a portion of the legs depending from the periphery of the portion of the support, and supporting means configured to support an edge of the raised platform portion adjacent the area of weakness.

22. A platform for microwave heating of a food product convertible from a joined configuration to a separated configuration to permit microwave heating of separate food products at different times, the platform comprising:
first and second platform portions, each having:
a support for supporting a food product during microwave heating thereof;
a susceptor disposed on the majority of the support for conducting heat to a food product thereon during microwave heating;
walls extending from the support; and
a top disposed on the walls; and
an area of weakness joining the first and second platform portions when the platform is in the joined configuration and separable to convert the raised platform from the joined configuration to the separated configuration.

23. The platform of claim 22, wherein the top further comprises an area of weakness defining a removable portion configured to provide access into an interior of the platform.
